(19) United States
(12) Patent Application Publication
(10) Pub. No.: US 2010/0115328 A1
(43) Pub. Date: May 6, 2010

(54) Methods and Systems for Handling Device Failovers during Test Executions

(76) Inventors: Manoj Betawar, Fremont, CA (US); Purnendu Narayan, San Jose, CA (US); Dinesh Goradia, Fremont, CA (US)

Correspondence Address: Rajeev Madnawat, 1431 Arizona Ave, MILPITAS, CA, 95035, US

(21) Appl. No.: 12/608,846

(22) Filed: Oct. 29, 2009

Related U.S. Application Data
(60) Provisional application No. 61/109,996, filed on Oct. 31, 2008.

(51) Int. Cl. G06F 11/20

(52) U.S. Cl. 714/4; 714/E11.073

(57) ABSTRACT

A method of generating a test script to test a first device in a target system is disclosed. The method includes generating error handling programming instructions to identify failure of the first device, and generating programming instructions to route test commands in the test scripts to a second device in the target system. The second device is a failover device that takes over operations of the first device when the first device fails.

### RELATED APPLICATION(S)

This application claims the benefit of U.S. Provisional Application No. 61/109,996 filed on Oct. 31, 2008.

### BACKGROUND

Electronic systems often carry critical data and thus need to be tested prior to installation and use. Networking equipment or devices such as switches, routers, bridges, etc. are constructed from integrated circuit (IC) chips and boards that are themselves tested prior to installation in a chassis of a networking device. However, the final network device also needs testing before shipment to the end user.

A device can be tested by sending one or more device commands to the device and analyzing the response(s). However, if the device fails, the testing has to stop.

Networking devices are usually quite complex. To simplify understanding, such devices can be considered to operate on higher-level packets of data, and respond to higher-level commands, such as commands embedded inside packets. Various higher-level languages have been developed to aid in testing of network devices. Such languages include TCL/TK. TCL is a Tool Command Language, while TK is Toolkit with a graphical user interface.

Network devices are often managed after installation in an operating network. Since network devices may be manufactured by different manufacturers, a standard has been developed for such management agents and management information databases. The Simple Networking Management Protocol (SNMP) is a protocol used for network management of various devices. SNMP also includes a set of commands which can be understood by the devices. These SNMP commands include commands to get (read) a particular statistic from a device, to set operating values or limits in a router/switch, and to trap or perform some task, such as notify the console when a particular event occurs such as a limit being exceeded.

A newly-manufactured network device could be tested prior to shipment by inserting it into a network at the test facility. The test engineer could manually enter SNMP commands from a console to test operating of the network device. These commands could be saved into a script file that is later re-played for each new network device inserted into the test-facility network for testing. However, manual testing can be tedious and prone to errors. Each new network device tested has a different range of network addresses assigned to it, and the script files have to be edited to insert the new network addresses for each network device tested.

### SUMMARY

In one embodiment, a method of generating a test script to test a first device in a target system is disclosed. The method includes generating error handling programming instructions to identify failure of the first device, and generating programming instructions to route test commands in the test scripts to a second device in the target system. The second device is a failover device that takes over operations of the first device when the first device fails.

### BRIEF DESCRIPTION OF THE DRAWINGS

FIG. 1 illustrates a device testing system coupled to a device under test in accordance with one or more embodiments of the present invention.

FIG. 2 illustrates an exemplary test script to test a device in accordance with one or more embodiments of the present invention.

### DETAILED DESCRIPTION

In complex electronic systems such as network routers, a failover mechanism is provided in which the operations of a device are taken over by a standby device having same or similar characteristics.

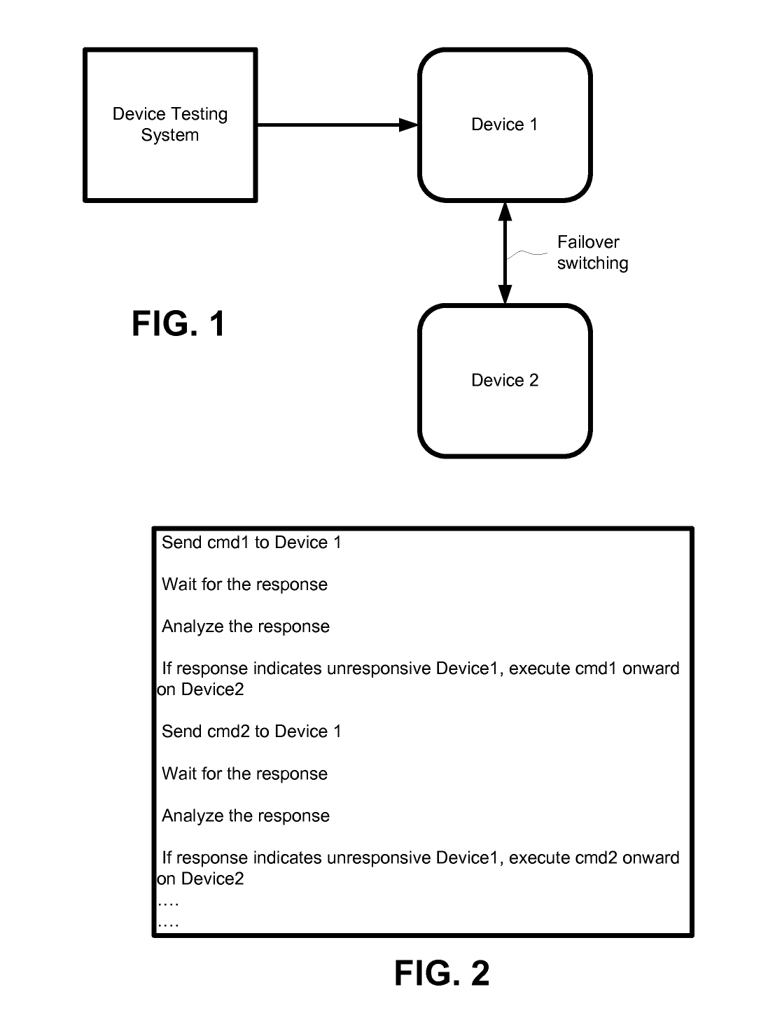

FIG. 1 illustrates a system having two devices, Device 1 and Device 2. In one example, these devices are main processing boards of a network router. Device 1 configured to control network packet routing operations and Device 2 is a standby device to provide the same operations. Device 1 and Device 2 are in a contract in which Device 2 is to take over the operations of Device 1 in the case Device 1 fails. In one embodiment, after Device 2 fails after taking over the operations of Device 1, the testing system attempts to send the subsequent commands to Device 1 again, if the script or the test generator is not configured to route the subsequent commands to any other standby device.

The Device Test System, as shown in FIG. 1, is couple to Device 1. The Device Test System, in one example is Sapphire TestSmart™ system. The Device Test System provides generation of device test cases. A device test case includes a sequence of device commands including necessary parameters to test a particular testing scenario on a particular type of device.

U.S. Pat. No. 7,010,782, entitled “Interactive automatic-test GUI for testing devices and equipment using shell-level, CLI, and SNM,” which is incorporated herein by reference, describes the testing of devices. U.S. patent application Ser. No. 11/423,974 entitled “Method and Apparatus for Executing Commands and Generation of Automation Scripts and Test Cases,” which is being incorporated herein by reference, describes generation of test scripts and test cases. U.S. patent application Ser. No. 11/368,916 entitled “Automatic Generation of System Test Libraries,” which is being incorporated herein by reference, describes generation of test libraries for testing devices.

Referring now to FIG. 2, the Device Test System generates scripts and test cases for testing a particular scenario for Device 1. A generated test script includes one of the SNMP command, CLI command, device native commands, native command encapsulated in Java or other high level languages, etc.

During the generation of a test script, the address of a device is provided to a test script generator in the Device Test System. The device address is then included in the test script. However, if the device for which the test script was generated fails to respond anytime during the execution of the test script, the testing process halts. In order to overcome this issue, the address of another device (ex. Device 2 in FIG. 1) that is in contract with the first device to provide a failover switch is provided to the script generator.

The script generator then generates test scripts with an error handling functionality. In one embodiment, the script generator embeds programming instructions to wait for the response from a device after sending a command to the device. During the wait, if a special error code indicating device failure is received, the Device Test System automatically starts sending the failed command and all subsequent commands to the second device. As mention earlier, the second device provides the same or similar functionality as the first device and also supports the same or similar command set.

In one embodiment, the test code generator embeds error handling code in the generated test script itself. The error handling code including programming instructions to detect either a time out of a device failure response from a device during a text execution and makes changes in the device addressing so that the failed command and all subsequent commands are addressed to a new device. This new device is a device that takes over the operations of the failed device in the target system that is being tested. In this embodiment, the generated test script can be executed in any commonly available device test frameworks.

In another embodiment, the error handling code, after detecting a device failure, instruct the Device Testing System to route the failed command and all subsequent commands to a new device. In this embodiment, the test script does not need to be changed.

The various embodiments described herein may employ various computer-implemented operations involving data stored in computer systems. For example, these operations may require physical manipulation of physical quantities usually, though not necessarily, these quantities may take the form of electrical or magnetic signals where they, or representations of them, are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs) CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method of generating error handling programming instructions for a test script to test a first device in a target system, the method comprising:
generating programming instructions for detecting a failure of the first device, wherein the failure is detected when the first device does not return a response to a command;
generating programming instructions for routing subsequent commands destined for the first device after the failure of the first device is detected to a second device in the target system; and
embedding the programming instructions for detecting a failure and the programming instructions for routing subsequent commands in the test script after every “send” command in the test script, wherein the “send” command sends a command to a device in the target system for command execution by the device,
wherein the second device is a failover device that is configured to take over operations of the first device when the first device fails.

2. The method as recited in claim 1, wherein, the programming instructions for detecting a failure are capable of being executed in the target system.

3. The method as recited in claim 1, wherein the generation of the programming instructions for detecting a failure includes generating programming instructions for receiving an input from a user to identify an output format of the generated programming instructions for detecting a failure.

4. The method as recited in claim 1, wherein the generation of the programming instructions for detecting a failure includes generating programming instructions for re-sending the failed command to the second device.

5. The method as recited in claim 3, wherein the output format is Java™,

6. The method as recited in claim 3, wherein the output format is a custom format that is supported by the target system.

7. The method as recited in claim 1, wherein the test script being created prior to the embedding the programming instructions, the creation of the test script includes:
(a) selecting the first device in a command terminal, wherein the selecting includes retrieving connection parameters for the first device;
(b) connecting to the first device using the connection parameters;
(c) enabling input of a text string in the command terminal, wherein the text string includes a command;
(d) storing the text string in a history buffer, the history buffer storing previously executed commands;
(e) displaying the text string in a command history panel of the command terminal, the command history panel displays content of the history buffer:
(f) sending the text string to the first device;
(g) displaying a response from the first device in the command terminal:
(h) enabling a user to select and unselect a text string in the command history panel; and
(i) storing the selected content of the history buffer in a data file that represents the test script, wherein the unselected content not being stored in the test case, wherein the command terminal including a command emulator panel to facilitate entry of the text string and to display a response of the first device to the text string.

8. A computer readable media having programming instructions for generating error handling programming instructions for a test script to test a first device in a target system, the computer readable media comprising:
programming instructions for generating programming instructions for detecting a failure of the first device, wherein the failure is detected when the first device does not return a response to a command;
programming instructions for generating programming instructions for routing subsequent commands destined for the first device after the failure of the first device is detected to a second device in the target system; and
programming instructions for embedding the programming instructions for detecting a failure and the programming instructions for routing subsequent commands in the test script,
wherein the second device is a failover device that is configured to take over operations of the first device when the first device fails.

9. The computer readable media as recited in claim 8, wherein, the programming instructions for detecting a failure are capable of being executed in the target system.

10. The computer readable media as recited in claim 8, wherein the programming instructions for the generation of the programming instructions for detecting a failure includes programming instructions for generating programming instructions for receiving an input from a user to identify an output format of the generated programming instructions for detecting a failure.

11. The computer readable media as recited in claim 8, wherein the programming instructions for the generation of the programming instructions for detecting a failure includes programming instructions for generating programming instructions for re-sending the failed command to the second device.
